(19) United States
(12) Patent Application Publication
(10) Pub. No.: US 2014/0138185 A1
(43) Pub. Date: May 22, 2014

(54) ADJUSTABLE TREE STAND

(71) Applicant: Shalan Samona, Farmington Hill, MI (US)

(72) Inventor: Shalan Samona, Farmington Hill, MI (US)

(21) Appl. No.: 13/938,633

(22) Filed: Jul. 10, 2013

Related U.S. Application Data
(60) Provisional application No. 61/669,946, filed on Jul. 10, 2012.

(51) Int. Cl. A01M 31/02

(52) U.S. Cl. CPC A01M 31/02
USPC 182/187

(57) ABSTRACT

An all-aluminum frame tree stand includes a foldable frame and a width-adjustable, telescoping arms for improving the securing and use of the tree stand with differing size trees.

### CROSS-REFERENCE TO RELATED APPLICATION

This application is a non-provisional application which claims the benefit of U.S. Patent Application No. 61/669,946; filed Jul. 10, 2012, which is hereby incorporated by reference in its entirety.

### FIELD

The present disclosure relates generally to an adjustable platform support assembly. In particular, the present disclosure relates to an adjustable and collapsible platform support assembly for use as a tree stand for supporting a user, such as a hunter, at an elevated position.

### BACKGROUND

Portable tree stands are used for supporting individuals such as photographers, observers, nature enthusiasts, arborists and hunters at an elevated position in a tree. An elevated position is desirable for many reasons such as better observing wildlife and being able to better hunt animals like deer. When hunting for deer, or other wildlife, it is desirable to gain the best tactical position available to increase one's field of vision and to place oneself out of the normal range of sight of the prey.

Tree stands come in standard sizes and are typically secured to the tree using a strap which goes around the tree is connected to the tree stand. In some designs the strap goes around a bar of the tree stand; and in some designs the ends of the strap are coupled or anchored to the sides of the tree stand. While tree stands are well known and come in many different types and designs, there remains a need to improve the use and function of such devices.

However, it can be the case that there are no appropriate size trees available in a prime location for the use of the tree stand (i.e., such as a prime hunting spot). It may happen to be that there is very large diameter or very small dianleter tree in a given area or at a specific location that is particularly ideal for a given reason. If so, the traditional portable tree stand may not be used or it may be unsafe. There are certain types of stands whose seats and platforms can be adjusted to provide leveling abilities where the tree is leaning or it is ideal to adjust the tree stand in a particular position or orientation. Still other tree stands provide adjustability for other features such as a holder for a camera, bow, gun or other item. Despite having all of these types of known adjustments, there remains a serious need to provide a tree stand that is better suited and capable of being better adapted for use in different size trees.

### SUMMARY

The present disclosure provides for a support device, such as a tree stand for use by a hunter, wherein the tree stand has improved adjustability so it may be more suitably used with a greater variety of trees having a greater variety of diameters. In one exemplary embodiment there is disclosed a tree stand having a frame for coupling the tree stand to the tree and a platform for supporting a person at an elevated position on a tree. The frame of the tree stand may include a pair of adjustable anchors that are located generally at the sides of the frame. The tree stand is securely coupled to the tree using a coupling member in the form of a chain and tire ends of the chain are removably secured to the adjustable anchors. For a tree having a relatively very large diameter the adjustable anchors may be extended outward from the frame in a direction generally perpendicular to the axis of the tree and in a direction generally perpendicular to the tree stand (i.e., in a width-wise direction). In one exemplary embodiment, the tree stand further may include a generally vertical back frame having a first end for pivotable connection with the frame and a second end spaced from the first end for pivotable connection with the platform such that a collapsible tree stand is provided.

In one exemplary embodiment, the frame may include a first, upper member and a second, lower member and each of the first and second members include width adjustable members or anchors and each having a coupling member having a length for passing generally horizontally around the tree to secure the tree stand to the tree. In one embodiment the coupling member is preferably configured to generally be rigid and self-supporting in a first direction aligned with the central axis of the pole or tree (i.e., the vertical direction) and generally freely movable in a direction perpendicular to the first direction (in a plane generally parallel to the ground), the coupling member having a first end portion to be releasably secured to the first adjustable anchor of the frame and a second end portion to be secured to the second adjustable anchor of the frame wherein the first and second anchors are length adjustable for providing adjustability to the coupling member for coupling the tree stand to trees having varying diameters.

In one embodiment the platform is preferably pivotably coupled to back frame to provide a collapsible tree stand. The tree stand may also include first and second supports for coupling the back frame and the platform to provide added support to the platform in a substantially horizontal position when supporting a person on the platform. The supports may be any known or appropriate support member and in one embodiment are a steel wire having an end coupled to the back frame member and one end coupled to the side of the platform for transferring the load to the back frame coupled to the tree and reducing the load applied to the pivotable coupling between the back frame and the platform.

In one embodiment the tree stand further may include tree-engaging or engagement members coupled to one of the back frame and the platform for providing vertical support to the tree stand by engaging the outer surface of the post (such as the bark of the tree). In one embodiment, the engagement members are preferably located at a first end of the platform for engaging the tree to limit movement of the tree stand in the vertical direction on the tree. In one embodiment, the tree-engaging members are movably coupled to the tree stand and can be width adjusted for providing improved engagement of the engagement member with the tree.

In one embodiment the coupling member is a chain strap having a plurality of holes and wherein the first and second adjustable anchors each include n pin for being received in a hole in the chain to couple the chain to the anchor members. The first and second anchor members each include a first portion for being adjustably received by the frame and a second portion for adjustably receiving the coupling member. Each coupling preferably may include a locking member such as a pin or fastener of any known or appropriate design for providing optional locking of the parts so they may be relatively easily adjusted and then securely coupled for use in coupling the tree stand to the pole or tree.

### BRIEF DESCRIPTION OF THE DRAWINGS

FIG. 1 is a graphical, perspective view of a tree stand support in a first or use position according to an exemplary embodiment;

FIG. 2 is a graphical, top elevation view of the tree stand support of FIG. 1 according to the exemplary embodiment;

FIG. 3 is a graphical, side elevation view of the tree stand support of FIG. 1 according to an exemplary embodiment;

FIG. 4 is a graphical, partially-exploded perspective view of the tree stand support of FIG. 1 according to an exemplary embodiment;

FIG. 5 is a graphical, partial top elevation view of the width-adjustable member of the tree stand support of FIG. 1 according to an exemplary embodiment;

FIG. 6 is a graphical, partial front elevation view of the width-adjustable member of the tree stand support of FIG. 1 according to an exemplary embodiment;

FIG. 7 is a graphical, partial elevation front view of the width-adjustable member and the tree-engaging member of the tree stand support of FIG. 1 according to an exemplary embodiment;

FIG. 8 is a graphical, partial elevation end view of the width-adjustable member taken along the line 8-8 as shown in FIG. 7;

FIG. 9 is a graphical, elevation top view of the tree-engaging member of the tree stand support of FIG. 1;

FIG. 10 is a graphical, elevation end view of the tree-engaging member of the tree stand support of FIG. 9;

FIG. 11 is a graphical, partial elevation end view of the tree-engaging member taken along the line 11-11 in FIG. 9;

FIG. 12 is a graphical, perspective view of an adjustable climbing-type, tree stand according to an alternate exemplary embodiment;

FIG. 13 is a graphical, side elevation view of the adjustable climbing-type, tree stand of FIG. 12;

FIG. 14 is a graphical, end elevation view of the adjustable climbing-type, tree stand of FIG. 12;

FIG. 15 is a graphical, perspective view of a tree stand support in a first or use position according to an alternate exemplary embodiment;

FIG. 16 is a graphical, perspective view of a tree stand support in a first or use position according to an alternate exemplary embodiment;

FIG. 17 is a graphical, partial plan view of the tree stand support the alternate exemplary embodiment of FIG. 16;

FIG. 18 is a graphical, perspective view of a tree stand support in a first or use position according to a further alternate exemplary embodiment;

FIG. 19 is a partial, graphical, perspective view of the tree stand support in of FIG. 18 detailing the end of the width-adjustable member of the further alternate exemplary embodiment;

FIG. 20 is a partial, graphical, perspective view of the back frame of the tree stand support of FIG. 18 according to the further alternate exemplary embodiment;

FIG. 21 is a partial, graphical side view of the back frame of the tree stand support of FIG. 20; and

FIG. 22 is a partial, graphical, top view of the back frame of the tree stand support of FIG. 20 detailing the engagement with a tree.

### DETAILED DESCRIPTION

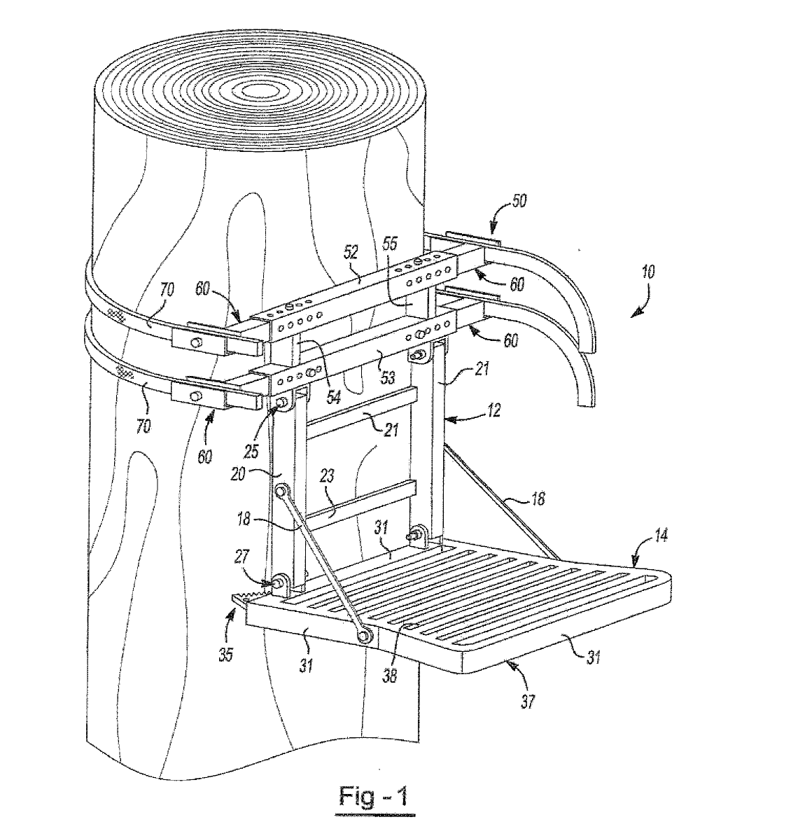

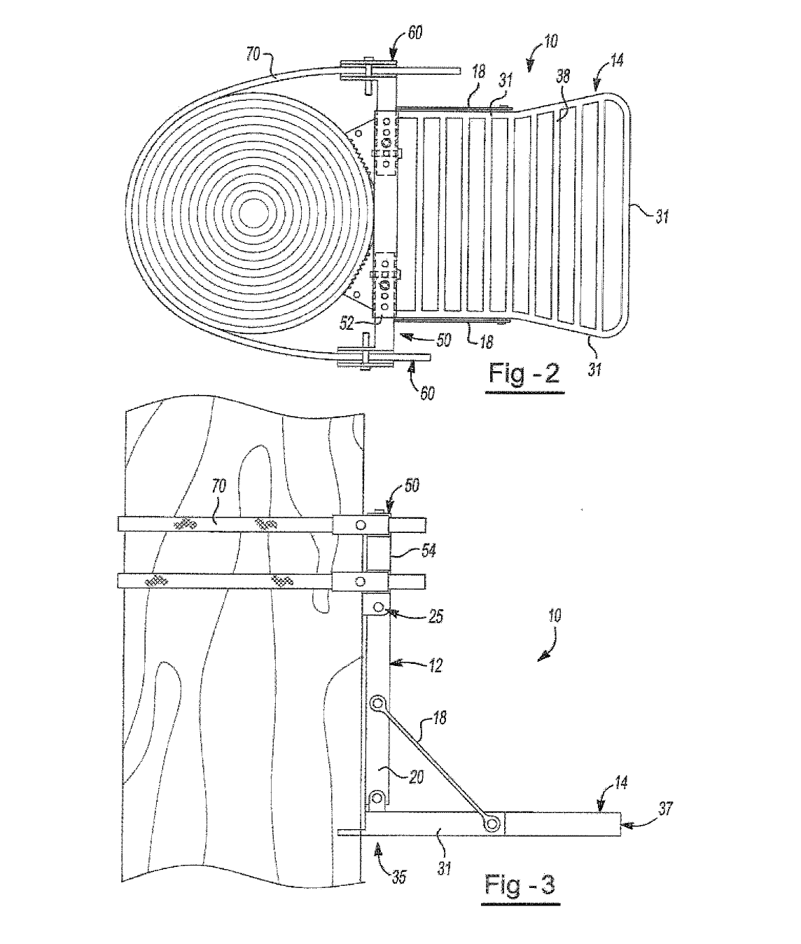

Referring generally to all of the Figures and in particular to FIGS. 1-4, an improved tree stand 10 according to an exemplary embodiment of the present disclosure is disclosed. The tree stand 10 may include a back frame 12 and a platform or support 14, the back frame 12 preferably may include first and second vertical members 20 and 22 and a pair of cross members 21 and 23. As such the back frame 12 is a relatively simple, substantially rectangular member made of four parts and having a first or upper end 25 and a second or lower end 27. The back frame 12 is preferably made from relatively lightweight and sufficiently strong material, such as a metal, metal alloy or high strength plastic and is, most preferably, made from aluminum or an aluminum alloy or other generally very light weight metal material. The back frame 12 is preferably assembled or manufactured using any known or appropriate techniques and, in particular, the pieces of the back frame 12 are preferably brazed or welded together using any known or appropriate process for the type of material being assembled. Alternatively, it should be understood that the back frame 12 may be made from any known or appropriate material and may be assembled using any known or appropriate devices or techniques such as fasteners, adhesives or others.

Similar to the back frame 12, the platform 14 is a relatively simple, substantially rectangular member made of a plurality of parts and having a first or proximal end 35 and a second or distal end 37, as also best disclosed in FIGS. 1 through 4. The platform 14 is also preferably made from aluminum or other generally very light weight metal material similar to, or the same as, the back frame 12 and is also preferably welded together using any known or appropriate welding process. The platform 14 is preferably pivotably coupled at the first end 35 to the second end 27 of the back frame 12. Any known or appropriate coupling, pivot or rotatable fastener may be used. In the embodiment disclosed, the platform 14 may include a plurality of dog ear shaped extensions or bosses having holes there through which are aligned with holes in the ends 27 of vertical members 20 and 22 of the back frame 12. Pins or rivets or any ether known or appropriate fasteners or devices are inserted through the holes in the dog ear shaped extensions and the holes in the ends 27 of the vertical members 20 and 22 for fixedly and pivotably couple the platform 14 to the back frame 12. Alternatively, it is possible to have a fixed, non-pivotable coupling between the back frame 12 and the platform 14.

The platform 14 may include a plurality of side members 31 which provide the platform 14 with a substantially rectangular outline shape. In one embodiment as disclosed in FIGS. 1 through 4, preferably the sides 31 extending perpendicularly away from the back frame 12 may be angled to increase the size of the platform 14 distally from the back frame 12 and the tree to which the tree stand Is attached. This provides the person standing on the platform 14 greater space to move and operate while using the tree stand 10. The platform 14 further may include a plurality of planks 38 spanning from one side member 31 to another side member 31 to provide a relatively even surface for supporting the person thereon. A pair of coupling members 18 are provided for supporting the platform 14 when it is in the use position as shown in FIGS. 1 through 4. Each coupling member 18 preferably has a first end coupled to one of the vertical members 20 and 22 and a second end coupled to one of the respective side members 31 of the platform 14. Each coupling member is preferably a length of flexible, steel cable designed to transfer loads from the platform 14 to the back frame 12 to lower the force applied to the coupling between me vertical members 20 and 22 and the end 35 of the platform 14.

The tree stand 10 further optionally may include an upper frame 50 pivotably coupled at the upper end 25 with the back frame 12 in a manner similar to how the end 27 the back frame 12 is coupled to the end 35 of the platform 14. Alternatively, the upper frame 50 and the back frame 12 may be coupled using any known or appropriate device or technique.

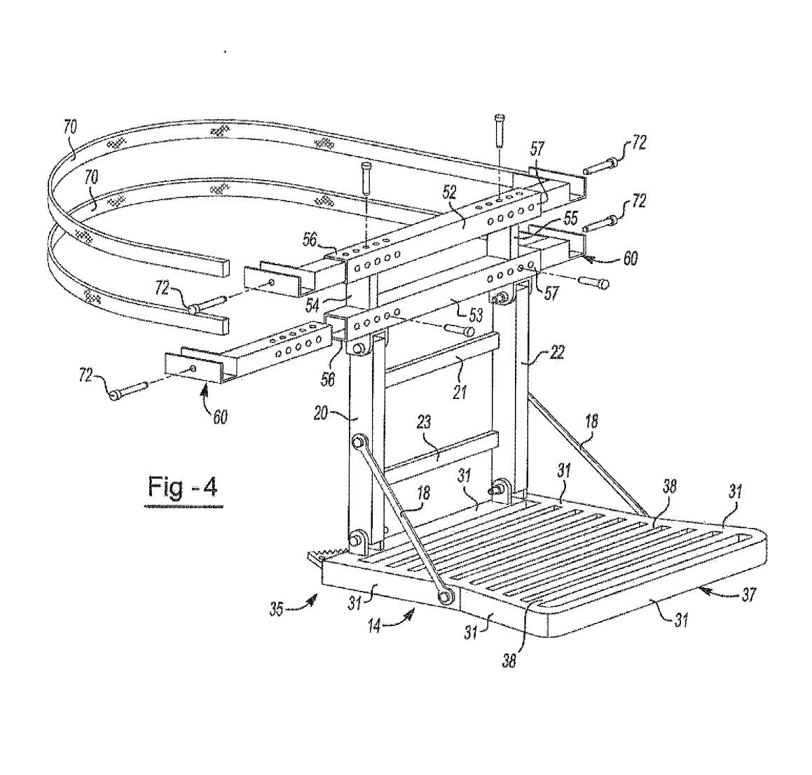

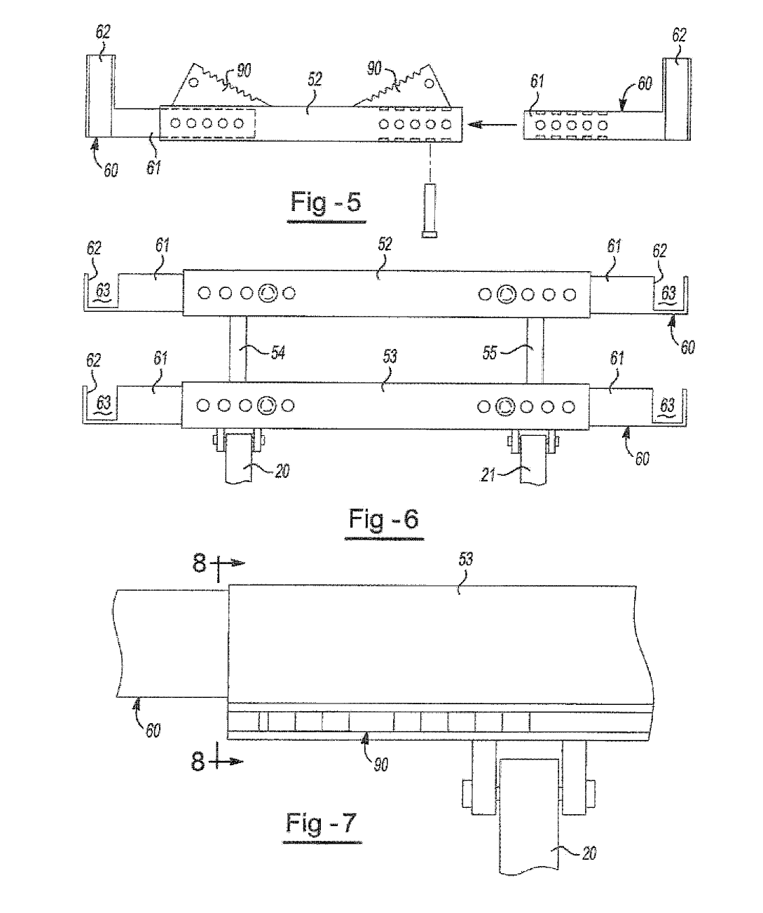

The upper frame 50 may include a first or upper member 52 and a second or lower member 53 spaced apart there from. Each of the first and second members 52 and 53 are preferably made from aluminum have a generally square, tubular cross section and construction. The first and second members 52 and 53 are preferably coupled by a pair of vertical members 54 and 55. The vertical members 54 and 55 may have a cross section similar to the first and second members 52 and 53 but may also have a different construction such as a sold member or other shaped cross section. The first and second members 52 and 53 and the pair of vertical members 54 and 55 are all preferably welded together using any known or appropriate welding process but may alternatively be coupled using any known or appropriate device or technique similar to the hack frame 12 and me platform 14. Each of the first and second members 52 and 53 have a first end 56 and a second end 57 having a hollow center for receiving therein a width-adjustable end member 60 having a substantially L-shaped form as further described herein and as disclosed in FIGS. 4 through 6.

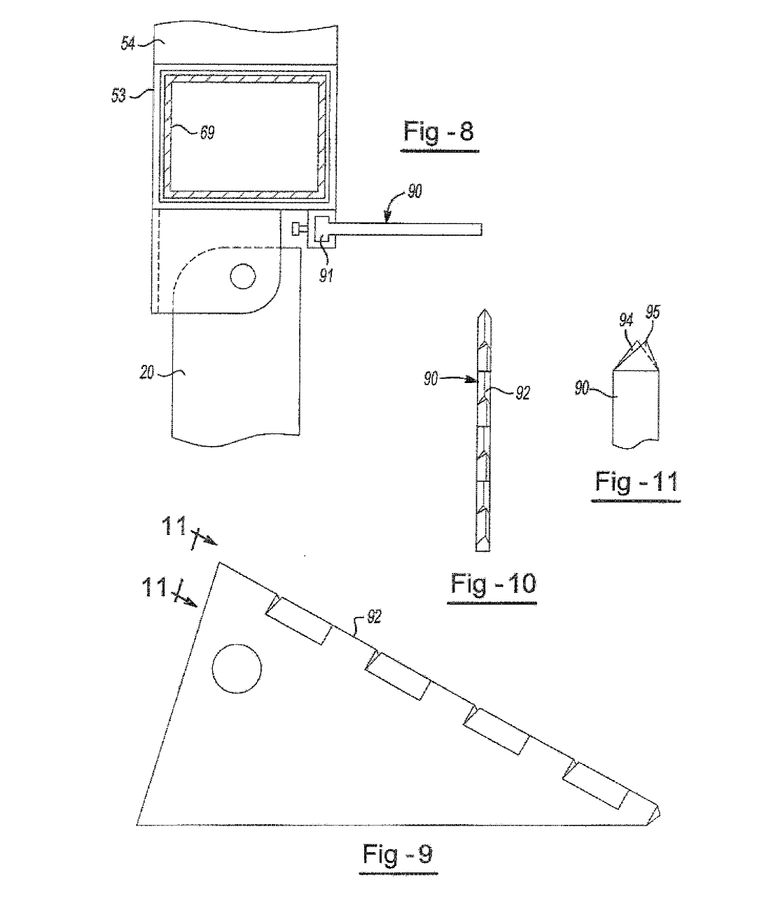

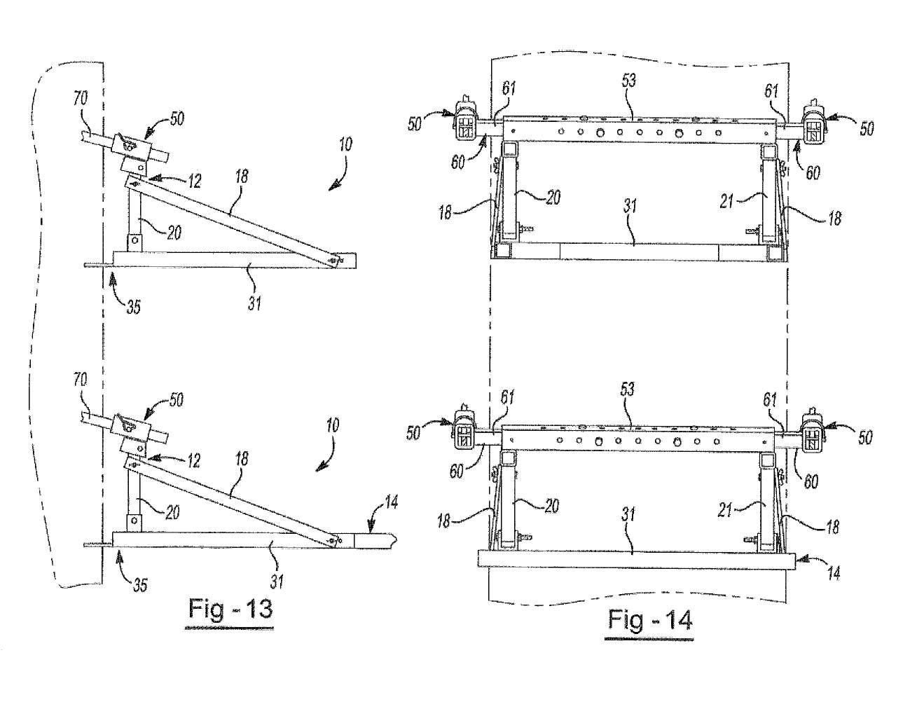

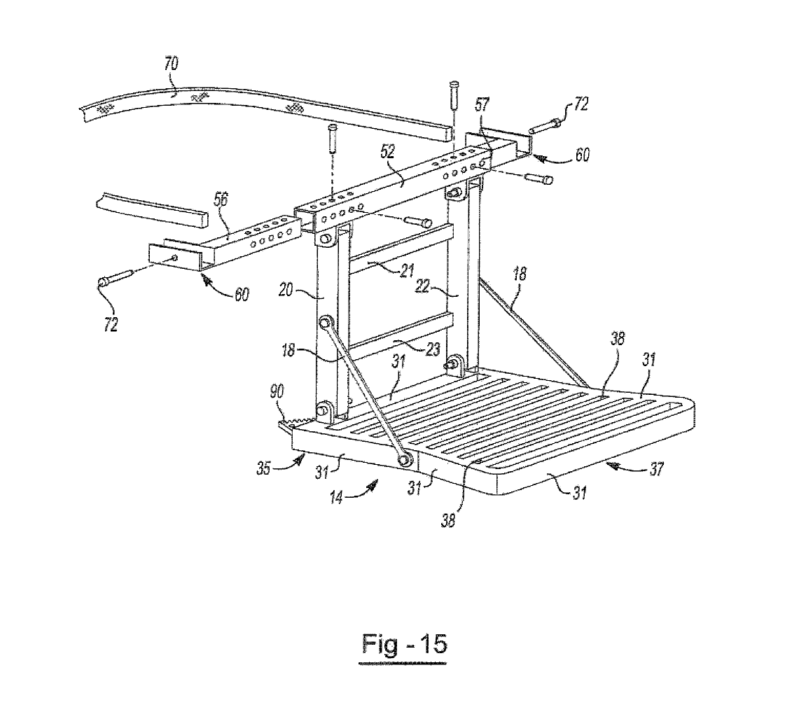

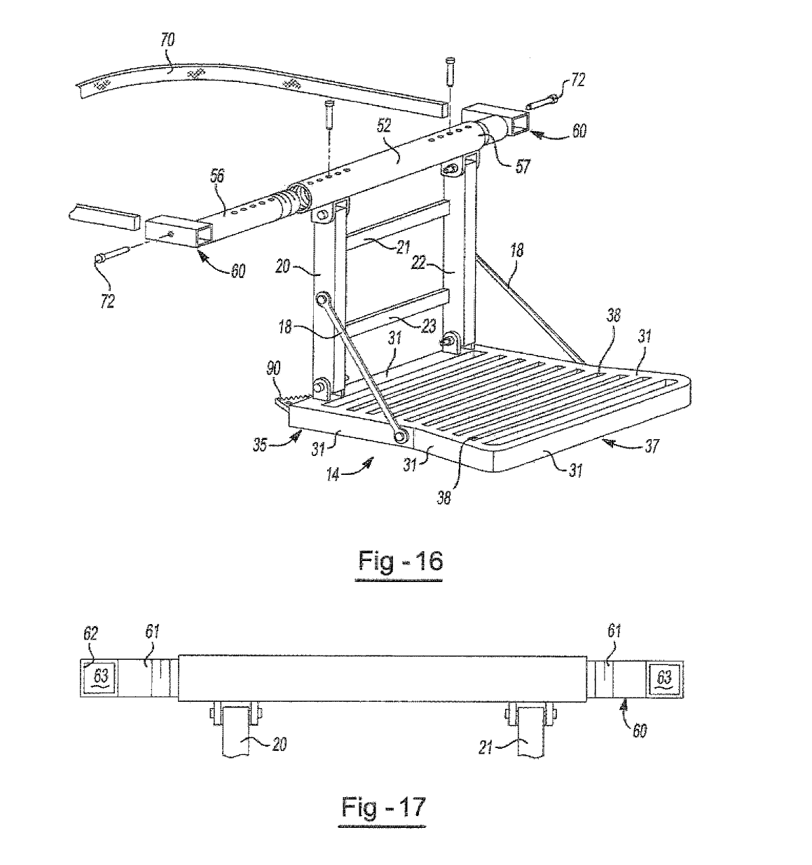

Referring now in particular to FIGS. 4-8, it may be seen that in one embodiment, each L-shaped, width-adjustable member 60 has a first leg or end member portion 61 and a second leg or end member portion 62. The L-shaped end members 60 disclosed in FIGS. 1-6 and 15-17 are a generally flat L shape in that the first and second legs 61 and 62 are in the same plane. In an alternate exemplary embodiment, as best shown in FIGS. 13 and 14, the second leg 62 is located on top of the first leg 61 such that they are no longer in the same plane. In particular, the second leg 62 is now supported on the leg 61 and is located above the cross member 52. Accordingly, it may be understood that it is possible to use a variety of differently shaped end members 60.

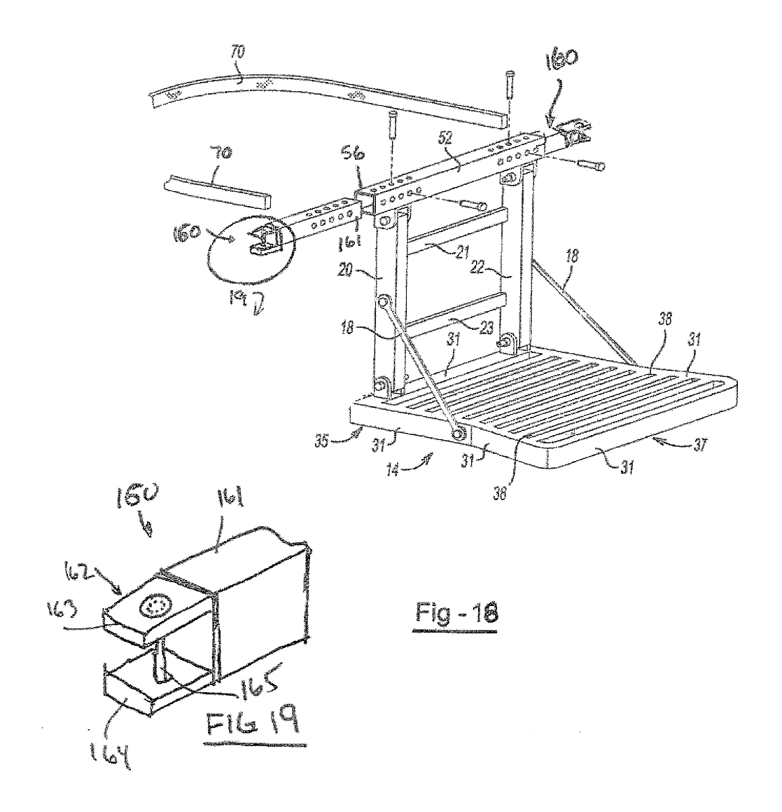

The second leg 62 may also be a preferably hollow, square tubular stock member that may be unitarily or integrally formed with the first leg 61 using any known or appropriate device or technique. Preferably the second leg 62 is welded to the first leg 61 using an appropriate aluminum welding or brazing technique. The second leg 62 is hollow and has a generally square cross-section and a generally square inner perimeter defining a passage 63. In one embodiment, such as disclosed in FIGS. 1-8 and 12-14, each of the first and second members 52 and 53 have a generally hollow center defining a substantially square cross-section 69 for receiving the generally square perimeter of the leg 61 of the L-shaped end member 60. Accordingly, the outer perimeter shape of the leg 61 preferably matches the inner perimeter shape of the cross member 52 (or 53 if there are two cross members) but it may be different. In an alternate embodiment as best disclosed in FIGS. 16 and 17, the leg 61 of the L-shaped end member 60 has a generally round cross-section and outer perimeter and the cross member 52 has an end 56 that is generally hollow and has a round cross-section having an internal thread. In this alternate embodiment, the end of the leg 61 preferably may include a thread on the outer perimeter that matches the thread on the inside of the end 56 of the cross member 52. The member 60 is preferably rotated to thread it into the end 56 of the cross member 52 to a desired position which provides a width-adjusted position and until a hole in the end 56 aligns with a hold in the leg 61 and a pin is inserted there through and secured in place such that the leg 61 is secured to the cross member 52.

Alternatively, it is possible that the elements do not match and that another device or technique is used to limit movement between each member 60 and the first and second cross members 52 and 53. As can be appreciated each end member 60 may be adjustably moved within the cross members 52 and 53 and then fixed in position using a pin member (or any other known or appropriate fixing device) passing through holes in each of the members and then the pin is secured in place using any known or appropriate securing device.

A coupling member 70, in the form of a plastic wrapped link chain, may be provided for coupling with the end members 60 by having an end of the chain 70 coupled to the end member 60 using a bolt or other type fastener 72. In one embodiment, as best disclosed in FIGS. 1-5 and 15, the leg 62 of the end member 60 has a space 63 for receiving the chain 70 wherein the space 63 is defined by only three (3) sides of the leg 62 such that the leg 62 does not include a top wall such that the coupling member 70 may be easily located and secured in the space 63. In an alternate embodiment, the leg 62 has a continuous perimeter (i.e., four sides for a square cross-section) and the coupling member 70 is inserted in the passage 63 from an end of the leg 62.

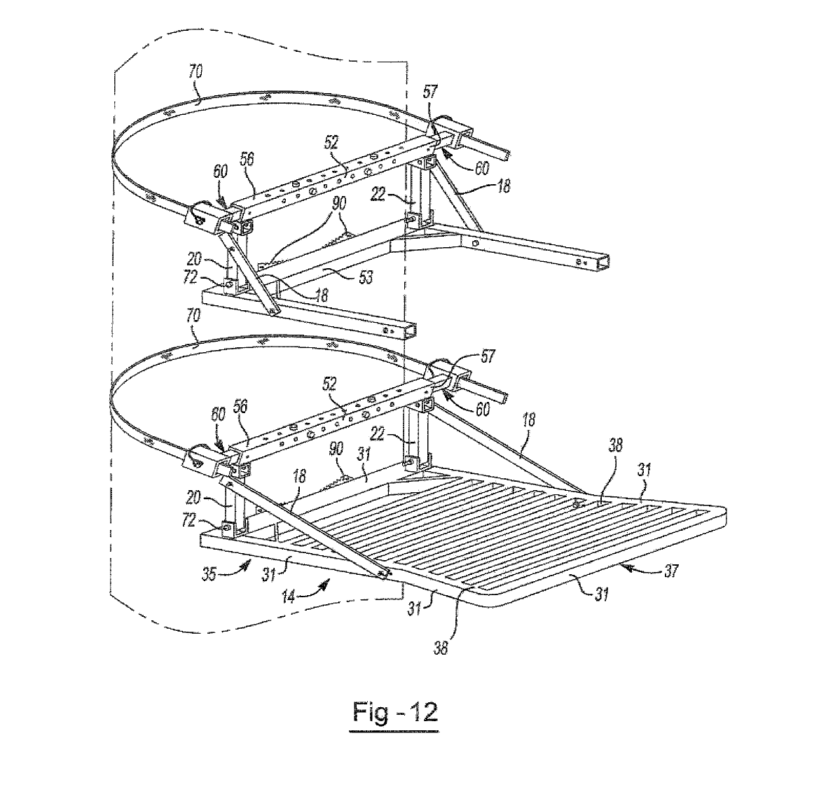

Referring now to FIGS. 12-14, there is disclosed an alternate embodiment of the tree stand 10 in the form of a climbing type tree stand 100 which may include a bottom or base climbing portion 101 and an upper climbing portion 101. Each of the bottom climbing portion 101 and the upper climbing portion 101 of the tree stand 100 include an upper cross member 52 similar to that of the tree stand 10 and at each end of each cross member 52 there is provided a width-adjustable member 60 similar to that of tree stand 10 such that the climbing tree stand 100 can be width adjusted to fit a variety of tree or pole diameter sizes while still functioning in a manner similar to known climbing tree stands. As noted previously, the width-adjustable member 60 of FIGS. 12-14 may have a variety of different configurations without departing from the present disclosure. In particular, it should be appreciated that the width adjustable members provide for adjusting the width of the frame of the tree stands 10 and 100 as well as providing for adjustment of the coupling member 70.

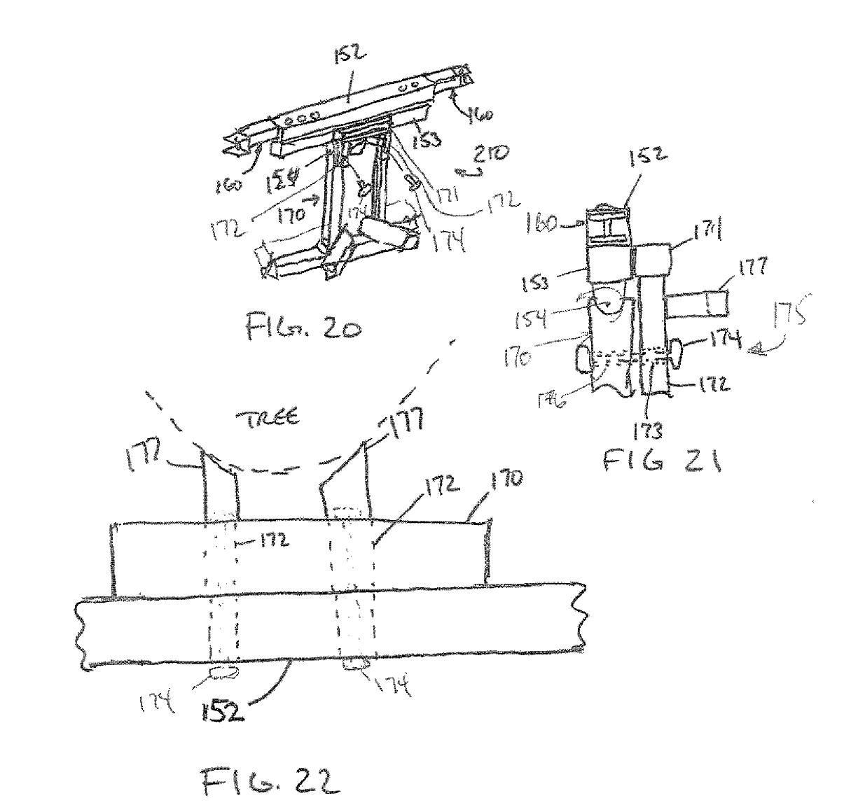

Referring now to FIGS. 18 and 19, there is disclosed a further alternate embodiment of the tree stand 10 wherein the width adjustable members 160 have a different design. As best shown in FIG. 19, the width-adjustable member 160 is a generally straight (no longer L-shaped) generally square-shaped, hollow cross section member having a simplified end 162 including a first generally flat, upper member 163 and a generally flat, lower member 164. The end 162 may be preferably made from a similar material as the leg 161 and may alternatively be integrally and/or unitarily formed therewith. The end 162 may include a cross member 165 extended between the members 163 and 164 in a generally vertical direction. Tile cross member 165 may be preferably a generally round cross-section member but may have any known or appropriate shape. The cross member 165 may be coupled with the members 163 and 164 in any known or appropriate manner including as a fastener, by welding or other means. In one embodiment, the cross member may be a pin having expanded ends and inserted through a hole located in each of the members 163 and 164 and fastened thereto. The cross member 165 may be designed to have an end of the coupling member 70 coupled thereto such as by having an S-hook located at an end of the coupling member 70.

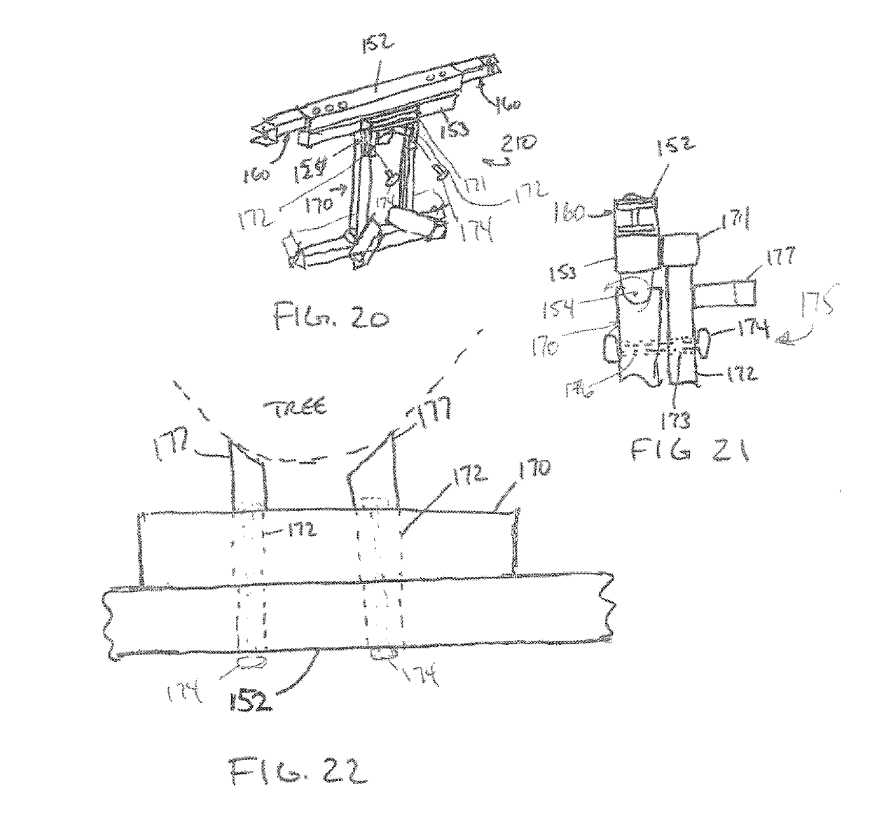

Referring now in particular to FIGS. 20-22, there is disclosed in a partial, perspective view in FIG. 20, a further exemplary embodiment of a tree stand 210. Similar to the tree stands 10 and 100, the tree stand 210 may include a cross member 152 having a pair of width-adjusting members 160. The cross member 152 may be supported on and preferably pivotably coupled to the upper end of the back frame 170, and as shown in FIG. 21, can alternatively be coupled to a cross member 153 using any known or appropriate coupling mechanism, coupler or other process such as welding, forming or the like.

The cross members 152 and 153 may be pivotably coupled to the back frame 170 at pivot member 154 similar to the previous embodiments. However, in the current embodiment of the tree stand 210, the cross members 152 and 153 are secured to the back frame 170 using a brace member 175 including a cross member 171 welded on the back side of the cross member 153 (or alternatively to the cross member 152) and having a pair of extension members 172 which align with the back frame members 170. Each extension member 172 is coupled to the respective back frame member 170 using a fastener 174 or other coupling or fastening device which passes through a respective hole 173 in the extension member 172 and a respective hole 176 in the back frame member 170. A pair of tree barbs 177 may be coupled to the extension members 172 for engaging a tree or other pole member. Since the tree barbs 177 engage the tree (not shown), the brace member or frame 175 is located between the back frame 170 of the tree stand 210 and the tree when the tree stand 210 is installed on the tree by having a coupling member 70 couple the tree stand 210 to a tree or pole. While it is possible to couple the tree stand 210 to the tree without having fasteners 174 fastening the brace member 175 to the back frame 170, using the fasteners 174 will prevent movement of the cross member 152 with respect to the back frame 170 and the platform 14 to enable a user to more readily install the tree stand 210.

Since the tree stand 210 uses cross member 165 for coupling with the coupling member 70 to the width-adjusting mechanisms 160 of the tree stand 210, the coupling member 70 can be made adjustable using any known or appropriate device, and the coupling member can include hooks or S-hooks, latches or other similar coupling members at the ends of the coupling member 70 for more easily and quickly coupling the coupling member 70 to the cross members 165 of the width-adjusting members 160.

It is understood that the above description is intended to be illustrative and not restrictive. Many other embodiments, combinations of disclosed and other embodiments, as well as many applications besides the examples disclosed will become apparent to those of skill in the art upon reading the above disclosures and teachings. The scope of the claimed invention should, therefore, be determined not solely with reference to the above descriptions, but should instead be determined with reference to the appended claims, giving them the full scope of meaning and equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

It will also be appreciated that the above disclosure is by way of illustrations only. The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein is intended to be an open term and to include additional elements, ingredients components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. A tree stand adapted for supporting a person at an elevated position on a tree, the tree having a central axis aligned substantially vertical to the ground, the tree stand comprising:
a frame configured for coupling the tree stand device to the tree, the frame having a first adjustable anchor located generally at a first side of the frame and a second adjustable anchor located generally at a second side of the frame;
a back frame having a first end coupled to the frame and a second end spaced from the first end;
a platform coupled to the second end of the back frame, the platform for supporting the person when the frame is coupled to the tree;
a coupling member having a length for passing generally horizontally around the tree to secure the tree stand to the tree, the coupling member configured to be generally rigid and self-supporting in a first direction aligned with the central axis of the tree and generally freely movable in a direction perpendicular to the first direction, the coupling member having a first end portion to be releasably secured to the first adjustable anchor of the frame and a second end portion to be secured to the second adjustable anchor of the frame wherein the first and second anchors are adjustable in a width direction aligned perpendicular to the generally vertical axis of the tree for providing adjustability to the coupling member for coupling the tree stand to trees having varying diameters.

2. The tree stand of claim 1 wherein the platform is pivotably coupled to back frame to provide a collapsible tree stand.

3. The tree stand of claim 2 further comprising a first tree engaging support coupled to the back frame and a second tree engaging support coupled to the platform to support the platform in a substantially horizontal position for supporting a person on the platform and transferring the load to the back frame coupled to the tree.

4. The tree stand of claim 1 further comprising engagement members coupled to the first end of the platform engaging the tree to limit movement of the tree stand in the vertical direction on the tree.

5. The tree stand of claim 1 wherein the coupling member is a chain strap having a plurality of holes and wherein the first and second adjustable anchors each include a pin for being received in a hole in the chain to couple the chain to the anchor member.

6. The tree stand of claim 1 wherein each of the first and second anchor members may include a first portion for being adjustably received by the frame and a second portion for adjustably receiving the coupling member.

7. A support device adapted for supporting a person at an elevated position on a pole, the pole having a central axis aligned substantially vertical to the ground, the support device comprising:
a first frame configured for coupling the support device to the pole, the first frame having a first anchor member located generally at a first side of the first frame and a second anchor member located generally at a second side of the first frame;
a second frame coupled to the first frame, the second frame for supporting the person when the first frame is coupled to the pole;
a coupling member having a length for passing generally horizontally around the pole to secure the support device to the pole, the coupling member configured to be generally rigid and self-supporting in a first direction aligned with the central axis of the pole and generally freely movable in a direction perpendicular to the first direction, the length having a first end portion releasably secured to the first anchor member of the first frame and a second end portion secured to the second anchor member of the first frame wherein the first and second anchor members are adjustable in a width direction aligned perpendicular to the generally vertical axis of the pole for providing adjustability to the coupling member for coupling the support device to poles having varying diameters.

8. The support device of claim 7 wherein the second frame member is pivotably coupled to first frame member to provide a collapsible support device.

9. The support device of claim 8 further comprising first and second supports coupling the first and second frames to support the second frame in a substantially horizontal position for supporting a person on the second frame and transferring the load to the first frame coupled to the pole.

10. The support device of claim 7 further comprising engagement members coupled to the first frame, the engagement members for engaging the pole to limit movement in the vertical direction of the support device on the pole.

11. The support device of claim 7 further comprising a third frame having a first end pivotably coupled to the first frame and a second end pivotably coupled to the second frame such that the third frame interconnects the first and second frames to provide a collapsible device.

12. The support device of claim 7 wherein the coupling member is a chain strap having a plurality of holes and wherein the first and second adjustable anchors each include a pin for being received in a hole in the chain to couple the chain to the anchor member.

13. The tree stand of claim 7 wherein each of the first and second anchor members may include a first portion for being adjustably received by the frame and a second portion far adjustably receiving the coupling member.

14. A tree stand adapted for supporting a person at an elevated position on a tree, the tree having a central axis aligned substantially vertical to the ground, the tree stand comprising:
a back frame configured for coupling the tree stand to the tree, tile back frame having a first end and a second end spaced from the first end;
a platform coupled to the second end of the back frame, the platform for supporting the person when the frame is coupled to the tree;
a tree engaging member movably coupled to one of the back frame and the platform, the tree-engaging member having a plurality of edges for engaging the tree to limit movement of the tree stand vertically along the tree, wherein the tree-engaging member can be moved width-wise as compared to the center axis of the tree and is selectively, fixedly coupled to the tree stand such that the tree-engaging member may be adjusted to a width-wise position to improve the engagement of the tree-engaging member and the tree to secure the tree stand to the tree.

15. The tree stand of claim 14 wherein the tree-engaging member has a substantially triangular shape and the hypotenuse of the triangle comprises the plurality of edges for engaging the tree.

16. The tree stand of claim 15 wherein the plurality of edges are defined by a plurality of teeth formed of the tree-engaging member.

17. The tree stand of claim 16 wherein the tree-engaging member has a first side and a spaced apart second side and the plurality of edges are alternatingly aligned with the first and second side along the hypotenuse.

18. The tree stand of claim 14 further comprising a second tree-engaging support movably coupled to one of the back frame and the platform and having a plurality of teeth for engaging the tree to limit vertical movement of the tree stand along the tree.

19-25. (canceled)
